(19) United States
(12) Patent Application Publication
(10) Pub. No.: US 2006/0019812 A1
(43) Pub. Date: Jan. 26, 2006

(54) Drilling fluid conditioning tank and centrifuge combination

(76) Inventor: Willie Stalwick, Edmonton (CA)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 11/143,080

(22) Filed: Jun. 2, 2005

(30) Foreign Application Priority Data
Jul. 22, 2004 (CA) 2,476,933

(51) Int. Cl. B04B 11/00

(52) U.S. Cl. 494/42

(57) ABSTRACT

A drilling fluid conditioning tank and centrifuge combination. The drilling fluid conditioning tank has more than two individual compartments. A centrifuge supply conduit extends length-wise in the tank. The conduit has a plurality of inlets, with at least one inlet being positioned in each of the individual compartments. The centrifuge is connected to the conduit. A pump is provided which is adapted to pump drilling fluids along the conduit to the centrifuge. A valve is positioned on each inlet for the conduit. By opening and closing selected valves, a selected one of the individual compartments is isolated and fluids are pumped by the pump to the centrifuge from only the selected one of the individual compartments.

### FIELD OF THE INVENTION

The present invention relates to a drilling fluid conditioning tank and centrifuge combination.

### BACKGROUND OF THE INVENTION

Canadian Patent 2,385,092 (Stalwick 2002) describes a method and apparatus for preventing accumulations of solids in a drilling fluid conditioning tank. In accordance to the teachings of the Stalwick patent, individual compartments of the drilling fluid conditioning tank are agitated with a fluid gun to fluidize the solids. The solids are then removed using a centrifuge.

When the Stalwick drilling fluid conditioning tank was first sent out in the field, each compartment had its own hose connection and the centrifuge was sequentially connected first to one and then to another of the individual compartments by changing which hose connection the centrifuge was coupled to.

SUMMARY OF THE INVENTION

What is required is an improved drilling fluid conditioning tank and centrifuge combination.

According to the present invention there is provided a drilling fluid conditioning tank and centrifuge combination. The drilling fluid conditioning tank has more than two individual compartments. A centrifuge supply conduit extends length-wise in the tank. The conduit has a plurality of inlets, with at least one inlet being positioned in each of the individual compartments. The centrifuge is connected to the conduit. A pump is provided which is adapted to pump drilling fluids along the conduit to the centrifuge. A valve is positioned on each inlet for the conduit. By opening and closing selected valves, a selected one of the individual compartments is isolated and fluids are pumped by the pump to the centrifuge from only the selected one of the individual compartments.

### BRIEF DESCRIPTION OF THE DRAWINGS

These and other features of the invention will become more apparent from the following description in which reference is made to the appended drawings, the drawings are for the purpose of illustration only and are not intended to in any way limit the scope of the invention to the particular embodiment or embodiments shown, wherein:

FIG. 1 is a side elevation view, in section, of a drilling fluid conditioning tank and centrifuge combination in accordance with the teachings of the present invention.

FIG. 2 is an end elevation view of the drilling fluid conditioning tank illustrated in FIG. 1.

FIG. 3 is a side elevation view of the valve in the closed position.

FIG. 4 is a side elevation view of the valve in the open position.

### DETAILED DESCRIPTION OF THE PREFERRED EMBODIMENT

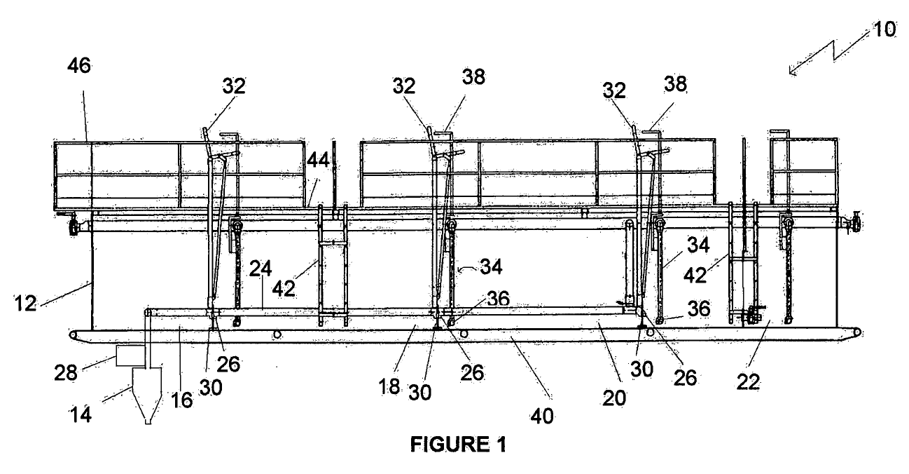

The preferred embodiment, a drilling fluid conditioning tank and centrifuge combination generally identified by reference numeral 10, will now be described with reference to FIGS. 1 through 4.

Structure and Relationship of Parts:

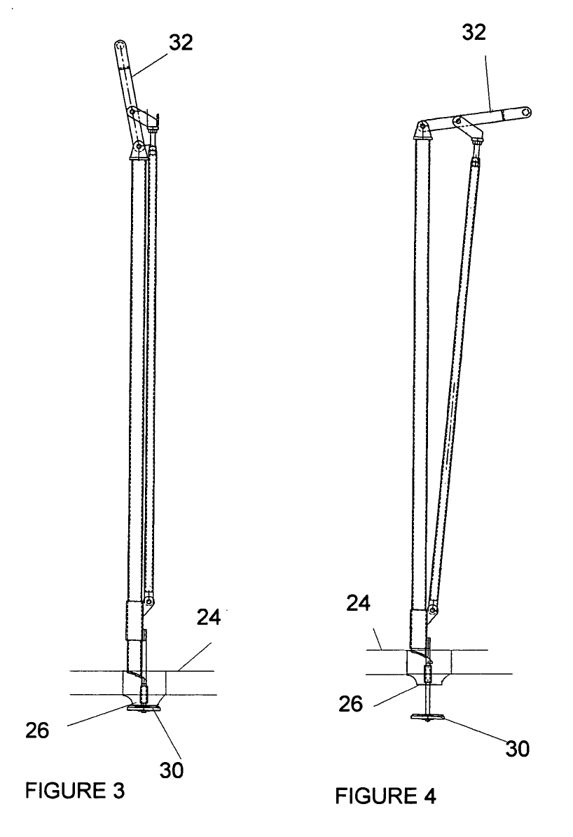

Referring to FIG. 1, there is illustrated drilling fluid conditioning tank and centrifuge combination 10 which includes a drilling fluid conditioning tank 12 and a centrifuge 14. Drilling fluid conditioning tank 12 has several individual compartments which are referenced in the illustrated embodiment as first compartment 16, second compartment 18, third compartment 20 and fourth compartment 22. A centrifuge supply conduit 24 extends length-wise in tank 12. Conduit 24 has a plurality of inlets 26, with one inlet 26 positioned in each of first compartment 16, second compartment 18, third compartment 20 and fourth compartment 22. Centrifuge 14 is connected to conduit 24. A pump 28 is provided which is adapted to pump drilling fluids along conduit 24 to centrifuge 14. A valve 30 is positioned on each inlet 26 for conduit 24. By opening and closing selected valves 30, a selected one of first compartment 16, second compartment 18, third compartment 20 or fourth compartment 22 is isolated and fluids are pumped by pump 28 to centrifuge 14 from that selected compartment. Each valve 30 is provided with a lever 32 for manually moving valve 30 from the closed position illustrated in FIG. 3 to the open position illustrated in FIG. 4. Each of first compartment 16, second compartment 18, third compartment 20 and fourth compartment 22 of tank 12 also includes a spray gun 34 with a nozzle 36. A handle 38 is provided for rotating nozzle 36.

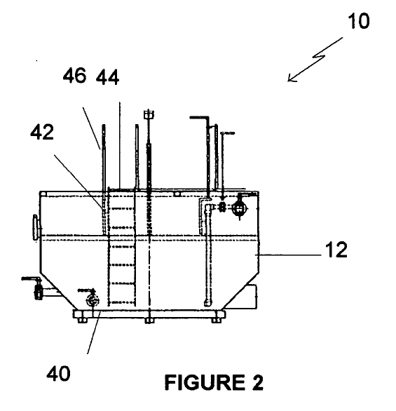

Referring to FIG. 2, in the illustrated embodiment, tank 12 is supported on a skid 40. Referring to FIG. 3, ladders 42 are provide for access to a walking platform 44 that overlies tank 12. A handrail 46 is provided along walking platform 44.

Operation:

The operation of drilling fluid conditioning tank and centrifuge combination 10, will now be described with reference to FIGS. 1 through 4.

Referring to FIG. 1, by opening and closing selected valves 24, a selected one of first compartment 16, second compartment 18, third compartment 20 or fourth compartment 22 can be isolated and fluids are pumped by pump 28 to centrifuge 14 from that selected individual compartment. By way of example, to isolate first compartment 16 from second compartment 18, third compartment 20 and forth compartment 22, valves 30 in second compartment 18, third compartment 20 and forth compartment 22 are moved to the closed position as illustrated in FIG. 3. Referring to FIG. 1, fluids are pumped by pump 28 to centrifuge 14 from first compartments 16. Second compartment 18, third compartment 20 and forth compartment 22 can be isolated in a similar manner when required.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent to one skilled in the art that modifications may be made to the illustrated embodiment without departing from the spirit and scope of the invention as hereinafter defined in the Claims.

The embodiments of the invention in which an exclusive property or privilege is claimed are defined as follows:

1. A drilling fluid conditioning tank and centrifuge combination, comprising:
a drilling fluid conditioning tank having more than two individual compartments;
a centrifuge supply conduit extending length-wise in the tank, the conduit having a plurality of inlets with at least one inlet being positioned in each of the individual compartments;
a centrifuge connected to the conduit;
a pump adapted to pump drilling fluids along the conduit to the centrifuge; and
a valve on each inlet for the conduit, such that by opening and closing selected valves, a selected one of the individual compartments is isolated and fluids are pumped by the pump to the centrifuge from only the selected one of the individual compartments.
